(19) United States
(12) Patent Application Publication
(10) Pub. No.: US 2013/0152645 A1
(43) Pub. Date: Jun. 20, 2013

(54) ACTUATING UNIT FOR AUTOMOTIVE APPLICATIONS

(71) Applicants: Thorsten Bendel, Oberhausen (DE); Claus Topfer, Sindelfingen (DE); Winfried Schlabs, Bochum (DE)

(72) Inventors: Thorsten Bendel, Oberhausen (DE); Claus Topfer, Sindelfingen (DE); Winfried Schlabs, Bochum (DE)

(73) Assignee: KIEKERT AKTIENGESELLSCHAFT, Heiligenhaus (DE)

(21) Appl. No.: 13/819,696

(22) PCT Filed: Aug. 31, 2010
(86) PCT No.: PCT/DE2010/001013

§ 371 Date: Feb. 27, 2013

(51) Int. Cl. E05B 65/12

(52) U.S. Cl. CPC E05B 81/06
USPC 70/277

(57) ABSTRACT

Actuating unit for automotive applications, especially motor vehicle door locks (1), comprising a drive (2) and with an actuator (3, 4) which can be pressurised by the drive (2), wherein the actuator (3, 4) is wholly or partially made of plastic.

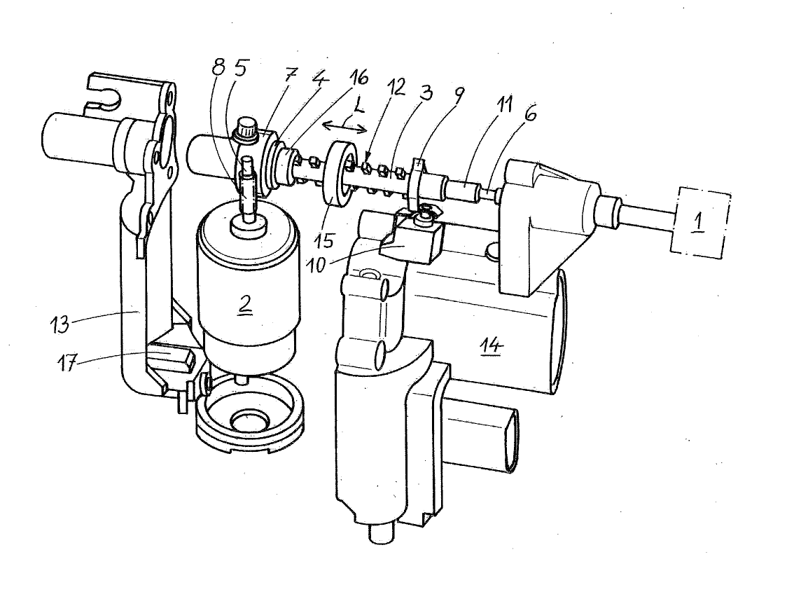

### FIELD OF THE INVENTION

The invention relates to an actuating unit for automotive applications, especially motor vehicle door locks, with a drive, and with a linear actuator which can be pressurised by the drive.

### BACKGROUND OF THE INVENTION

Such actuating units for automotive applications and here in particular motor vehicle door locks are known from practice and are comprehensively described in literature. Reference is made to the type-defining DE 10 2005 044 458 B4 in this regard for example. This involves closure equipment with a closure aid for a door, a flap or a lid of a motor vehicle. To this end, a knee lever arrangement can be moved between an open position and a closed position. The knee lever arrangement can be activated into its closed position via an actuating drive to move a closure element.

Besides, such actuating units exist for example in conjunction with seats, mirrors, headrests, etc. which can be electrically operated. These have been tried and tested in principle, but are usually constructed in an expansive and sturdy manner. As the actuating units in question do not transmit negligible forces or torques.—As weight issues increasingly have a part to play in automobile construction, and admittedly due to ecological perspectives, additional installations in general and actuating units are also viewed critically although they play a crucial role in improving comfort. This is where the invention is used.

### SUMMARY OF THE INVENTION

Underlying the invention is the technical problem of further developing such an actuating unit for automotive applications so as to attain a compact, lightweight design.

To solve this technical issue, a generic actuating unit is characterised as part of the invention by the fact that the actuator is made wholly or partially from plastic. The plastic used is either wholly or partially a self-reinforced polymer material. In actual fact, it is advantageous to use a liquid crystal polymer (at least in part). Such liquid crystal polymers are also named LCPs in English and are generally known by means of the EP 0 217 563 B1.

Such plastics are characterised by the fact that they can dispense with fibre reinforcement, whilst nevertheless demonstrating similar strengths to fibre-reinforced plastics. In actual fact, liquid crystal polymers are characterised by a rod-shaped molecular shape. Such molecules have little flexibility. At the same time, outstanding mechanical and chemical qualities result from the rod-shaped molecular shape or the fact that the plastic comprises rod-shaped molecules.

Thus, liquid crystal polymers demonstrate extremely high tensile strength and a high elasticity module in parallel to their molecular axis. The liquid crystal polymers may be completely aromatic polyesters.

However, the plastic used in accordance with the invention—in addition or Completely—has a reinforcement in itself which can be attributed to the rod-shaped molecules of the liquid crystal material used at this point. Of course, a polymer composite material which comprises for example a thermoplastic base polymer and the aforementioned liquid crystalline polymer or the liquid crystal polymer can also be used as a plastic. One way or another, the actuator in accordance with the invention can be produced with particular ease as such plastics generally have densities in the range of 1 to 2 g/cm³ at most, in contrast to the steel with a density of more than 7 g/cm³ usually used. Such a substitute is possible as comparable strengths are observed as for the fibre-reinforced plastics and, for example, the elasticity module is situated in the range of more than 3000 N/mm², preferably even more than 4000 N/mm².

An almost identical degree of effectiveness is attained by the use of these plastics compared to the metal design. The advantage compared to glass fibre-reinforced plastics is the lower friction values and thus less wear.

The actuator is generally a linear actuator. It is advantageous if the linear actuator is formed as a spindle drive. A threaded spindle drive is usually used. In this regard, at least one spindle and one spindle nut housed on the spindle are executed.

A variant according to which the spindle nut is fixed in the housing is especially preferred. Thus, the spindle nut and an external toothed wheel on the spindle nut form a combined worm/spindle nut gearbox according to an advantageous arrangement. The worm/spindle nut gearbox can be formed as a single-piece component, especially a plastic component.

Generally, both the combined worm/spindle nut gearbox and also the spindle as such are respectively manufactured from the self-reinforced polymer or from a composite material which predominantly demonstrates the polymer material in question which is self-reinforced. This means that the weight proportion of the liquid crystal polymer in the aforementioned composite material is usually more than 50% by weight. Of course, it is part of the invention for example only to produce the adjustable spindle vis-à-vis the spindle nut from the special plastic in question or the stated composite material and to produce the combined worm/spindle nut gearbox from a conventional (thermoplastic) plastic.—However, as self-reinforced polymer materials or composite materials manufactured on this basis are easy to process by means of injection moulding or extrusion in the same way as customary thermoplasts, it is recommended to manufacture both components from the plastic in accordance with the invention. In actual fact, both the worm/spindle nut gearbox and the spindle can respectively involve (single-piece) plastic injection moulded components.

The configuration will usually be selected in such a way that the self-reinforced polymer material or the liquid crystal polymer has an arrangement of its rod-shaped molecules which predominantly follows the longitudinal side of the linear actuator. That means that the rod-shaped molecules of the liquid crystal polymer are generally arranged along the spindle in order to give the spindle the necessary strength and the described high elasticity module in a longitudinal direction. In contrast, crosswise to this direction, considerably lower values are observed for tensile strength and the elasticity module. This can be attributed to the greatly anisotropic geometry of such liquid crystal polymers. Furthermore, such liquid crystal polymers are characterised by great temperature resistance which enables application areas with temperatures in excess of 100° C. (cf. EP 0 217 563 B1). Consequently, the plastic materials in question are predestined for motor vehicle use with temperatures of up to 80° C.

As the spindle of the customarily used linear actuator is generally made of plastic, it would seem appropriate to connect the spindle to a connected connecting means. Linear actuating movements of the spindle can be transmitted via this connecting means to a connected and pressurised motor vehicle door lock for example. The connecting means can be connected to the spindle via a connection piece. In actual fact, it is advantageous to connect the spindle or generally the actuator with the connection piece in question for the connecting means on the head side, detachably or non-detachably. The connection piece and the spindle can be designed as a single component.

Furthermore, the spindle or generally the actuator tends to demonstrate a connected component for the triggering of a sensor. This sensor may be a mechanical switch. In this case too, the component and the spindle can be manufactured as a single component, consequently the spindle can ultimately be produced cost-effectively in conjunction with the component and the connection piece in a single-step production process. This ultimately also applies to the thread provided for on the outer circumferential surface of the spindle. Because this thread can be integrated into the single-step manufacturing process—as can the entire spindle manufacture. Where the spindle is formed as a plastic injection moulded component at this point, the spindle, the thread, the component and finally also the connection piece can consequently be produced in one go. Naturally, the component can also be screwed onto the spindle or detachably connected to it otherwise.

At the same time, the sensor triggering component functions as an anti-twist safeguard for the spindle.

The thread may be designed in an interrupted manner. In one way or another, the thread engages at the outer circumferential surface of the spindle into a continuous internal thread of the spindle nut. Thus, rotational movements of the spindle nut which is fixed into a housing are directly transmitted to the spindle moving backwards and forwards axially to it.

As a result, an actuating unit for automotive applications is provided which can transmit comparable forces or torques to a conventional actuating unit. This all succeeds at a considerably lighter weight, because the actuator or linear actuator used at this point is wholly or partially made of plastic. The actuator is usually completely made of plastic. This process does not use customary plastic, but one which wholly or at least partly contains self-reinforced polymer material. The proportion of the self-reinforced polymer material is usually over 50% by weight. The plastic is therefore a composite material. One way or another, additional fibre reinforcements are not necessary.

Instead, the plastic can be exactly made up to the requirements. Because the plastic is predominantly a liquid crystal polymer which has special characteristics due to the rod-shaped molecules. Where these rod-shaped molecules are predominantly oriented in on the longitudinal side of the linear actuator or a spindle used at this point, the spindle in question or the linear actuator as a whole demonstrates the required strength, especially in the axial actuating direction specified by the spindle. In fact, the spindle is moved backwards and forwards in a linear direction. The spindle nut housed on the spindle ensures this.

In order to further reduce the weight at this point, the aforementioned spindle nut together with a worm gearbox forms a combined worm/spindle nut gearbox. This is advantageously formed as a single-piece component, especially a plastic component. This not only simplifies manufacture, but also installation. Because the drive which is usually executed as an electric motor only needs to be equipped with a worm wheel on its output shaft, which engages in the external toothed wheel of the combined worm/spindle nut gearbox for linear adjustment of the spindle. The fundamental advantages can be seen here.

### BRIEF DESCRIPTION OF THE DRAWING

The invention is explained in greater detail hereinafter on the basis of a sketch which only constitutes an execution example. The only figure shows an actuating unit in perspectival explosion depiction in accordance with the invention.

Other features and advantages of the present invention will become apparent from the following detailed description, taken in conjunction with the accompanying drawings which illustrate, by way of example, the principles of the invention.

### DETAILED DESCRIPTION OF THE INVENTION

An actuating unit for automotive applications is depicted in the figure. In actual fact, the purpose of the actuating unit is predominantly to pressurise a motor vehicle door lock 1 and is not restricted to a closure device here. With the aid of such a closure device, a ratchet of the motor vehicle door lock 1 can be transferred into a completely closed position as explained in detail in the DE 10 2005 044 548 B4 stated above.

The actuating unit has a drive 2 which involves an electric motor 2. The drive 2 pressurises an actuator 3, 4 which is formed as a linear actuator 3, 4 as an example and is not limited to this. To this end, an output shaft 5 of the drive or electric motor 2 comes with a fixed location spindle nut 4 of the linear actuator 3, 4 which moves the relevant spindle 3 consistently backwards and forwards in a longitudinal direction L as indicated by an arrow.

As part of the example and not limited to this, the linear actuator 3, 4 is completely made of plastic. Thus, a plastic is used which predominantly contains a self-reinforced polymer material. The plastic in question is therefore a composite material which has a liquid crystal polymer in a weight proportion of over 50% by weight. Both the spindle nut 4 and also the spindle 3 have overall and respectively been manufactured as a plastic injection moulded component in one working step. The layout is executed in such a way that the rod-shaped molecules of the liquid crystal polymer are aligned at least in spindle 3 in such a way that they demonstrate an arrangement on the longitudinal side L. Spindle 3 is therefore capable of transferring large forces in this lengthwise direction L to a connected connecting means 6 which transmits the actuating movements of spindle 3 to the motor vehicle door lock 1 pressurised by this.

The linear actuator 3, 4 is—as already explained—a spindle drive, a thread spindle drive in the execution example. The spindle nut 4 which is permanently accommodated in the housing 14 has an external toothed wheel 7. Thus, the spindle nut 4 and the toothed wheel 7 form a single-piece component 4, 7 which is formed as a combined worm/spindle nut gearbox 4, 7. In fact, a worm wheel 8 which is arranged on the output shaft 5 and is only indicated engages into the external toothed wheel 7 in order to make the spindle nut 4 rotate. As a consequence of this, the spindle 3 which engages with spindle nut 4 moves in the longitudinal direction L, and namely either to the right or the left in the figure, dependent on in which direction the output shaft 5 of the electric motor 2 rotates.

In its linear movement, the spindle 3 with a connected component 9 negotiates a sensor 10 which is fitted out as a mechanical switch 10 in the example. With the aid of the switch 10 the movement of the actuator or linear actuator 3, 4 can be verified and stopped when a certain position is attained, for example. The component 9 is shaped onto the spindle 3 or forms a single-piece component 3, 9 with it. In the outlined example, this also applies to a connection piece 11 for the connecting means 6 which is provided for on the head side of the spindle 3. This means that the spindle 3, the flange 9 and the connection piece 11 together form a modular unit 3, 9, 11 or a single-piece plastic injection moulded component 3, 9, 11, which is connected with the connecting means 6.

The spindle 3 is fitted with a thread 12 on its outer circumferential surface. As part of the example but not restricted to this, this thread 12 is configured in an interrupted manner, and does not therefore possess continuous threads. Nevertheless, the interrupted thread 12 continuously engages in an internal thread of spindle nut 4 which is not explicitly depicted. Consequently, rotations of spindle nut 4 give rise to the desired actuating movements of spindle 3 in the longitudinal direction L.

The drive or electric motor 2, the actuating drive 3, 4 and sometimes the connecting means 6 are accommodated in a two-part housing 13, 14 overall. The housing 13, 14 comprises a lid section 13 and an upper section 14 for the electric motor 2 which can be connected to this. A bearing ring 15 is provided for to accommodate the spindle nut 4 or the combined worm/spindle nut gearbox 4, 7 in the housing 13, 14 which is fitted onto an attachment 16 of the spindle nut 4. The bearing ring 15 is, for example, but is not limited to, a ball bearing ring.

A latch 17 can also be recognised in the lid section 13 of the housing 13, 14 which functions as a counterlatch for the drive or electric motor 2. Thus, the electric motor or drive 2 can be perfectly underpinned vis-à-vis the lid section 13.—Naturally, as part of the invention, the component 9 is not constructed as a single piece with the threaded spindle 3, but instead must be attached to the spindle 3 via a screwable or otherwise detachable connection.

It is to be understood that the above-described embodiment is illustrative of only one of the many possible specific embodiments which can represent applications of the principles of the invention. Numerous and varied other arrangements can be readily devised by those skilled in the art without departing from the spirit and scope of the invention.

1. An actuating unit for automotive applications, namely motor vehicle door locks (1), with a drive (2), and with an actuator (3, 4) which can be pressurised by the drive (2), wherein the actuator (3, 4) is wholly or partially made of plastic.

2. The actuating unit in accordance with claim 1, wherein the plastic wholly or partially contains a self-reinforced polymer material.

3. The actuating unit in accordance with claim 2, wherein the self-reinforced polymer material comprises rod-shaped molecules which are predominantly arranged on the longitudinal side of the actuator (3, 4).

4. The actuating unit in accordance with one of the claims 1 to 3, characterised by the fact that the actuator (3, 4) as a linear actuator (3, 4), is preferably formed as a spindle drive.

5. The actuating unit in accordance with claim 1, wherein the actuator (3, 4) at least demonstrates a spindle (3) and a spindle nut (4) accommodated in a housing 14.

6. The actuating unit in accordance with claim 5, wherein the spindle nut (4) is permanently fixed in the housing 14.

7. The actuating unit in accordance with claim 5, wherein the spindle nut (4) together with an external toothed wheel (7) forms a combined worm/spindle nut gearbox (4, 7).

8. The actuating unit in accordance with claim 7, wherein the worm/spindle nut gearbox (4, 7) is formed as a single-piece component (4, 7), especially a plastic component (4, 7).

9. The actuating unit in accordance with claim 1, wherein the actuator (3, 4) demonstrates a connected connecting means (6) for the pressurisation of the motor vehicle door lock (1).

10. The actuating unit in accordance with claim 1, wherein the actuator (3, 4) demonstrates a connected component (9) for the triggering of a sensor (10), such as a switch (10), and this component (9) constitutes an anti-twist safeguard.

11. The actuating unit in accordance with claim 5, wherein the spindle (3) is equipped with a thread (12) especially an interrupted thread (12) on its outer circumferential surface, which engages into a continuous internal thread of the spindle nut (4).

12. The actuating unit in accordance with claim 9, wherein the actuator (3, 4) is connected with a connection piece (11) for the connecting means (6) on the head side.
